(19) United States
(12) Patent Application Publication
(10) Pub. No.: US 2026/0021660 A1
(43) Pub. Date: Jan. 22, 2026

(54) LIQUID EJECTION APPARATUS

(71) Applicant: CANON KABUSHIKI KAISHA, TOKYO (JP)

(72) Inventors: TSUKASA SANO, KANAGAWA (JP); YOSHIAKI MURAYAMA, TOKYO (JP); YUHEI OIKAWA, KANAGAWA (JP); RAN KUDO, TOKYO (JP); YASUHIKO OSAKI, KANAGAWA (JP); EIKOU MORI, TOKYO (JP); YU MITSUZUMI, KANAGAWA (JP)

(21) Appl. No.: 19/265,118

(22) Filed: Jul. 10, 2025

(30) Foreign Application Priority Data
Jul. 19, 2024 (JP) 2024-115817

(51) Int. Cl. B41J 2/135

(52) U.S. Cl. CPC B41J 2/135; B41J 2202/16

(57) ABSTRACT

A liquid ejection apparatus that can suppress occurrence of condensation in a printing head without causing an increase in size of the apparatus is provided. To this end, a first air flow generation structure is arranged in a position that is not in a conveyance direction with respect to the printing head and arranged so as to be able to blow an air flow to an ejection port surface of the printing head. In addition, a heat source is provided between a first air flow generation unit and the printing head to increase a temperature of the air flow from the first air flow generation structure.

### BACKGROUND

### Field of the Technology

The present disclosure relates to a liquid ejection apparatus that ejects a liquid onto a medium.

### Description of the Related Art

A liquid ejection apparatus that ejects an ink onto a printing medium and prints a character, an image, and so on has been known. In the liquid ejection apparatus, after a liquid is ejected from a printing head onto the printing medium, in a process of conveying the printing medium, water in the liquid, which is on the printing medium, evaporates. As a result, the periphery of the printing head becomes a high-humidity environment, and condensation may occur in the printing head.

In a case where the condensation occurs in the printing head, there is a possibility that a droplet from the condensation falls from the printing head on the printing medium, and the image quality of the printing medium is decreased.

Japanese Patent Laid-Open No. 2022-162406 discloses a configuration in which a blow-out structure that sends low-humidity air under a printing head is provided to vent the air under the printing head by utilizing a shape of an image formation medium.

However, since the configuration of Japanese Patent Laid-Open No. 2022-162406 provides the blow-out structure between two printing heads, an increase in size of the apparatus is concerned.

### SUMMARY

Therefore, the present disclosure provides a liquid ejection apparatus that can suppress occurrence of condensation in a printing head without causing an increase in size of the apparatus.

Therefore, a liquid ejection apparatus of the present disclosure includes: a printing unit in which an ejection port from which a liquid is ejected onto a printing medium is arrayed in a second direction crossing a first direction in which the printing medium is conveyed; a first air flow generation unit that can generate an air flow; and a heat source that can generate heat, in which the first air flow generation unit and the printing unit are arranged in a position in which the first air flow generation unit and the printing unit overlap in the first direction, and the air flow generated by the first air flow generation unit passes through the heat source and reaches an ejection port surface provided with the ejection port in the printing unit.

According to the present disclosure, it is possible to provide a liquid ejection apparatus that can suppress occurrence of condensation in a printing head without causing an increase in size of the apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating an example of a schematic configuration of a liquid ejection apparatus;

FIG. 2 is a perspective view illustrating a printing head;

FIG. 3 is a perspective view illustrating a print module;

FIG. 4 is a diagram illustrating a configuration example of a second air flow generation structure and the printing head;

FIGS. 5A and 5B are diagrams illustrating a printing unit;

FIG. 6 is a diagram illustrating an air flow generated by a first air flow generation structure as a flow line;

FIGS. 7A, 7B, 7C, 7D, and 7E are diagrams illustrating the print module;

FIGS. 8A and 8B are diagrams illustrating the print module;

FIG. 9 is a diagram illustrating a part of the printing unit;

FIGS. 10A and 10B are diagrams illustrating a part of the printing unit;

FIG. 11 is a diagram illustrating a part of the printing unit;

FIG. 12 is a diagram illustrating a part of the printing unit; and

FIG. 13 is a diagram illustrating the print module.

### DESCRIPTION OF THE EMBODIMENTS

### First Embodiment

A first embodiment of the present disclosure is described below with reference to the drawings.

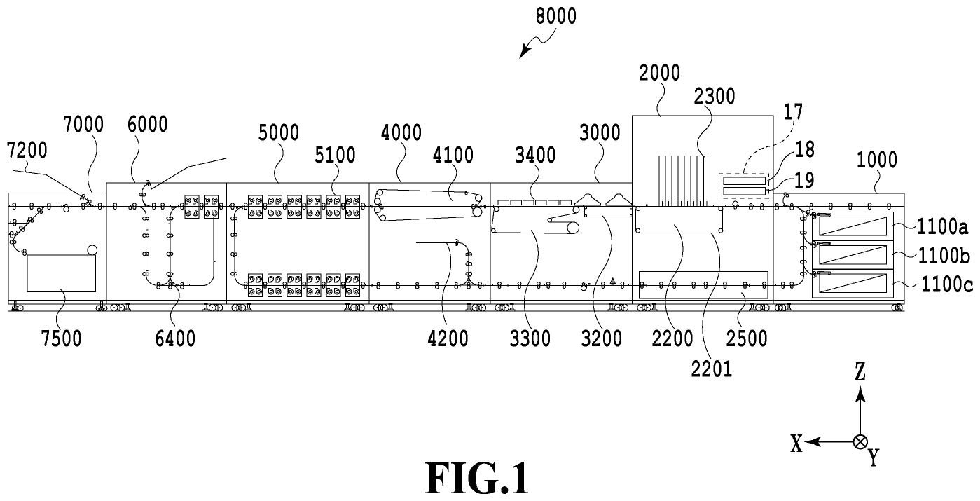

FIG. 1 is a schematic view illustrating an example of a schematic configuration of a liquid ejection apparatus 8000 in the present embodiment. The liquid ejection apparatus 8000 is a sheet-fed type ink jet printing apparatus that forms an image on a sheet, which is a printing medium such as a printing paper, by using two types of liquids, which are a primer and an ink.

The liquid ejection apparatus 8000 includes modules, which are a feeding module 1000, a print module 2000, a drying module 3000, a fixation module 4000, a cooling module 5000, an inversion module 6000, and a discharging and stacking module 7000. A sheet in the form of cut paper that is supplied from the feeding module 1000 is conveyed along a conveyance route, processed by each module, and discharged to the discharging and stacking module 7000.

In the feeding module 1000, three storages that store the sheet, which are a storage 1100a to a storage 1100c, are arranged, and the storage 1100a to the storage 1100c are configured to be drawable to an apparatus front side (a −Y direction). In each of the storage 1100a to the storage 1100c, the sheet is fed one by one by a separation belt and a conveyance roller and conveyed to the print module 2000. Note that, the number of the storages is not limited to three and may be one, two, or four or more.

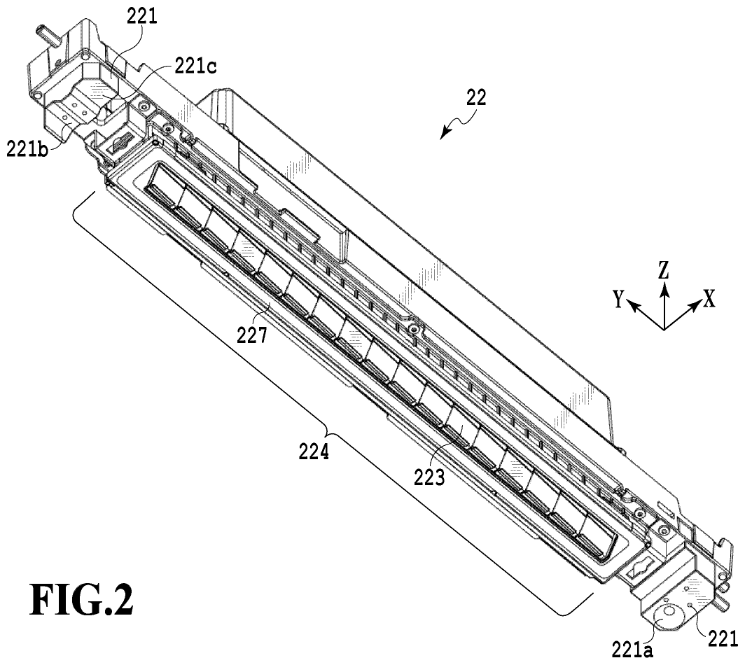

The print module 2000 includes a not-illustrated pre-image formation registration correction unit, a print belt unit 2200, and a printing unit 2300. The sheet conveyed from the feeding module 1000 is corrected by the pre-image formation registration correction unit such that a tilt and a position of the printing paper are corrected and conveyed to the print belt unit 2200. The printing unit 2300 is arranged in a position facing the print belt unit 2200 with respect to the conveyance route. In the print belt unit 2200, multiple printing heads 22 (see FIG. 2) are arrayed along a conveyance direction (an X direction, a first direction). The printing unit 2300 forms the image on the sheet conveyed in the X direction by performing printing processing on the sheet by the printing heads from above. A clearance between the sheet and the printing head 22 is secured by sucking and conveying the sheet by a conveyance belt 2201 of the print belt unit 2200. In the present embodiment, five line-type printing heads in total are included, which correspond to four colors, which are Y (yellow), M (magenta), C (cyan), and Bk (black), and additionally P (primer). Note that, the number of colors and the number of the printing heads are not limited to five.

As a liquid ejection method in the printing head, it is possible to adopt a method using a heating element, a method using a piezoelectric element, a method using an electrostatic element, a method using an MEMS element, or the like. Each color of ink is supplied from a not-illustrated ink tank to the printing head via a corresponding ink tube. The sheet on which the printing is performed by the printing unit 2300 is conveyed by the print belt unit 2200, and a not-illustrated in-line scanner arranged downstream of the printing unit 2300 in the conveyance direction detects misregistration and a color density of the image formed on the sheet to correct a printing image.

The drying module 3000 includes a decoupling unit 3200, a drying belt unit 3300, and a warm air blowing unit 3400. In the drying module 3000, a liquid component in the ink applied on the sheet by the printing unit 2300 is reduced in a short time, and the fixability between the sheet and the ink is increased. The drying module 3000 can increase the printing speed. The sheet on which the printing is performed by the printing unit 2300 of the print module 2000 is conveyed to the decoupling unit 3200 arranged in the drying module 3000. In the decoupling unit 3200, it is possible to convey the sheet by a wind pressure from above in a Z direction and a friction of the belt, and the sheet on the belt is held softly during the conveyance. Thus, displacement of the sheet on the print belt unit 2200 is prevented in a case of forming the image.

The sheet conveyed from the decoupling unit 3200 is sucked and conveyed by the drying belt unit 3300, and an ink-applied-surface of the sheet is dried by applying hot air from the warm air blowing unit 3400 arranged above the belt in the Z direction. Note that, as the drying method, in addition to the method of applying the hot air, a method of irradiating a sheet surface with electromagnetic waves (ultraviolet rays, infrared rays, or the like) and a conductive heat transfer method by contact with a heating device may be combined as needed.

The fixation module 4000 includes a fixation belt unit 4100 and fixes the ink on the sheet by causing the sheet conveyed from the drying module 3000 to pass between a heated upper belt unit and a lower belt unit.

The cooling module 5000 includes multiple cooling units 5100 and cools down the high-temperature sheet conveyed from the fixation module 4000. Each of the cooling units 5100 takes outside air into a cooling box with a fan, increases a pressure inside the cooling box, and blows wind coming out of a nozzle formed in a conveyance guide onto the sheet to cool down the sheet. The cooling units 5100 are arranged on two sides of the conveyance route and cool down the sheet from the two sides. Additionally, in the cooling module 5000, a conveyance route switching unit is included, and the conveyance route of the sheet is switched depending on a case of conveying the sheet to the inversion module 6000 and a case of conveying the sheet to a double-sided conveyance route used in double-sided printing.

In a case of the double-sided printing, the sheet is conveyed to a lower conveyance route in the cooling module 5000 and is further conveyed along the double-sided conveyance route of the fixation module 4000, the drying module 3000, the print module 2000, and the feeding module 1000. Then, again, the sheet is conveyed to the pre-image formation registration correction unit, the print belt unit 2200, and the printing unit 2300 in the print module 2000, and the printing is performed by the printing unit 2300. The double-sided conveyance unit of the fixation module 4000 includes a first inversion unit 4200 that flips over the sheet.

The inversion module 6000 includes a second inversion unit 6400, and it is possible to freely switch the discharged sheet between the front and back sides by flipping over the conveyed sheet.

The discharging and stacking module 7000 includes a top tray 7200 and a stacking unit 7500 and stacks the sheet conveyed from the inversion module 6000 in alignment.

A maintenance unit 17 includes a structure that recovers the ejection performance of the printing head. The structure for recovery may be, for example, a cap structure 18 that protects an ink ejection surface of the printing head and a recovering structure 19 that includes a wiper structure that wipes the ink ejection surface and a suction structure that sucks the ink in the printing head from the ink ejection surface with a negative pressure. Additionally, the maintenance unit 17 includes a driving structure and a rail, which are not illustrated, so as to be able to move reciprocally in a horizontal direction along the rail. In a case of maintenance of the printing head 22, the maintenance unit 17 can move either one of the cap structure 18 and the recovering structure 19 to a position immediately below the printing head 22, and in a case where no maintenance operation is performed, the cap structure 18 and the recovering structure 19 are moved to a position retracted from the position immediately below the printing head.

FIG. 2 is a perspective view illustrating the printing head 22. The printing head 22 is provided to extend in a Y direction crossing the sheet conveyance direction. An ejection port plate 223 including multiple ejection ports from which the ink is ejected is arrayed on the printing head 22 in a printing head longitudinal direction (a sheet width direction, the Y direction). The printing head longitudinal direction is a direction (a second direction) orthogonal to the conveyance direction of the printing medium. The periphery of the ejection port plate 223 is covered and protected by a face cover 227 made of resin, and a surface including the ejection port plate 223 and the face cover 227 is referred to as an ejection port surface 224.

The printing head 22 includes a positioning unit 221 at each of two end portions in the Y direction. Specifically, the printing head 22 includes a first abutment unit 221a formed of a recess portion including a conical-shaped inclined surface on a near side in the head longitudinal direction and a second abutment unit 221b formed of a groove portion including two V-shaped flat surfaces and a third abutment unit 221c formed of a flat surface portion on a far side in the head longitudinal direction.

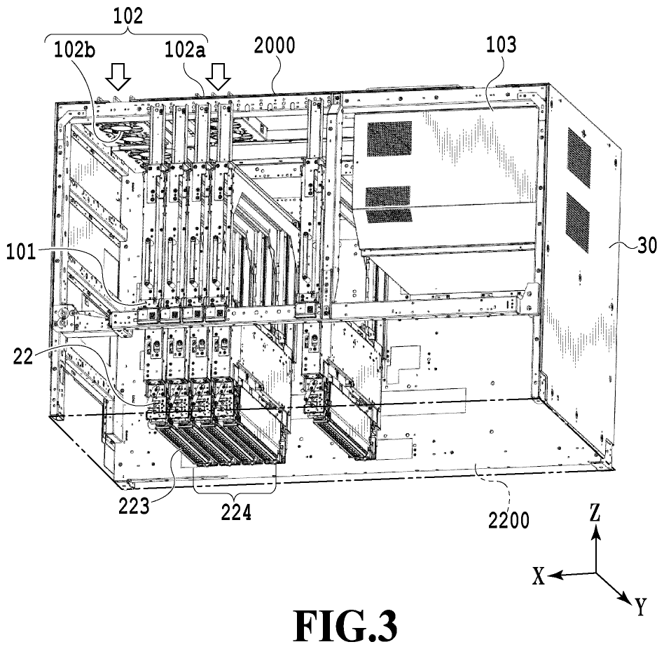

FIG. 3 is a perspective view illustrating the print module 2000. Note that, for explanatory convenience, the units other than the print belt unit 2200 are not illustrated. The print module 2000 in the present embodiment includes a first air flow generation structure 101 that sends an air flow to the ejection port surface 224 of the printing head 22 and a second air flow generation structure 102 that can send environment air around the apparatus (hereinafter, also referred to as outside air) to a space inside the apparatus. The first air flow generation structure 101 and the second air flow generation structure 102 correspond to a first air flow generation unit and a second air flow generation unit, respectively. Thus, a state in which condensation is unlikely to occur in an environment between the printing head 22 and an image formation surface of the sheet is obtained. A configuration of the first air flow generation structure 101 and the second air flow generation structure 102 is described below.

The first air flow generation structure 101 can generate the air flow and sends the generated air flow to the ejection port surface 224 of the printing head 22. Additionally, the print module 2000 includes a PC space 103 in which a PC can be mounted. In FIG. 3, the first air flow generation structure 101 is provided above the printing head 22 in a printing position in the Z direction, and the air flow generated by the first air flow generation structure 101 is blown to the ejection port surface 224 including the ejection port plate 223 of the printing head 22.

In a case where the first air flow generation structure 101 is arranged in the sheet conveyance direction with respect to the printing head 22, it is difficult to narrow an interval between the printing heads because there is the first air flow generation structure 101, and an increase in size of the apparatus in the conveyance direction, that is, an increase in size of an apparatus installation area is concerned. Therefore, preferable arrangement of the first air flow generation structure 101 is arrangement in a position in which at least a part of the first air flow generation structure 101 overlaps the printing head 22 in the sheet conveyance direction. To be more specific, it is preferable to arrange the first air flow generation structure 101 and the printing head 22 in a position in which the first air flow generation structure 101 and the printing head 22 overlap at least partially while viewing from the Z direction or in a position in which the first air flow generation structure 101 and the printing head 22 overlap at least partially while viewing from the Y direction. In the present embodiment, the former arrangement is applied, and the first air flow generation structure 101 and the printing head 22 are arranged to overlap while viewing from the Z direction.

Note that, it is possible to use a common fan as the first air flow generation structure 101. For example, it is possible to use a sirocco fan, a turbo fan, a ventilation fan, a pressure fan, an axial flow fan, and so on as the first air flow generation structure 101 depending on an apparatus space and a purpose. In the present embodiment, the axial flow fan is used as the first air flow generation structure 101 in terms of the relatively small size and a high air capacity with low noise. As for the number of the fan, two axial flow fans of 40 mm square (40 mm×40 mm) are arranged for each printing head. This corresponds to each of the four heads for black, cyan, magenta, and yellow and the one head for the primer, and thus ten axial flow fans in total are used. In this case, the size of the axial flow fan is not limited to the above-described size, and the size may be 16 mm square to 60 mm square (16 mm×16 mm to 60 mm×60 mm), for example. In addition, the shape is not limited to that described above.

The second air flow generation structure 102 sends the environment air around the apparatus to the space inside the apparatus. In FIG. 3, the second air flow generation structure 102 sucks the outside air from the outside of the print module 2000 and blows the air to the position of the first air flow generation structure 101. The second air flow generation structure 102 is provided to an upper surface of a housing 30 of the print module 2000 in an in-use orientation.

Note that, it is unnecessary to arrange the second air flow generation structure 102 above the first air flow generation structure 101 in the Z direction as illustrated in FIG. 3, and it is possible to blow the air from a side surface and the like from any angles toward the first air flow generation structure 101. However, a configuration in which the outside air from the second air flow generation structure 102 is sent to a space between the first air flow generation structure 101 and the ejection port surface 224 is not preferable because the air flow generated by the first air flow generation structure 101 and the outside air from the second air flow generation structure 102 interfere with each other and cause air flow stagnation in the apparatus.

In the present embodiment, the second air flow generation structure 102 arranged on the upper surface of the housing 30 in the Z direction to send the outside air to the space inside the apparatus includes a fan 102a and a fan 102b. The fan 102a is provided within a range overlapping a projected area of the multiple printing heads in the Z direction, and the fan 102b is provided outside the range of the projected area of the multiple printing heads in the Z direction. Note that, use of the two types of fans in the second air flow generation structure 102 is not an essential requirement. In the present embodiment, the print module 2000 includes two second air flow generation structures 102 including two fans 102b and one second air flow generation structure 102 including two fans 102a.

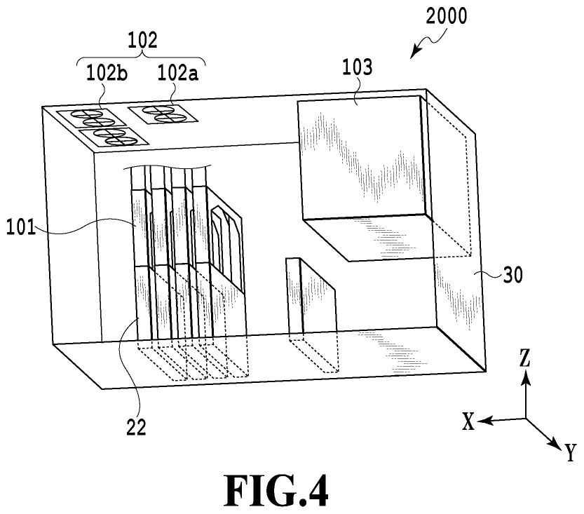

FIG. 4 is a diagram illustrating a positional relationship between the second air flow generation structure 102 and the printing head 22 in the print module 2000 in the present embodiment. The second air flow generation structure 102 may be installed in one portion of the housing 30 as long as it is possible to sufficiently blow the air to the first air flow generation structure 101 above the printing head 22. However, blowing to the first air flow generation structure 101 from two or more positions like the fans 102a and 102b in FIG. 4 is preferable because it is possible to suppress the diffusion of the air flows from each other without wasting the blown air to the first air flow generation structure 101.

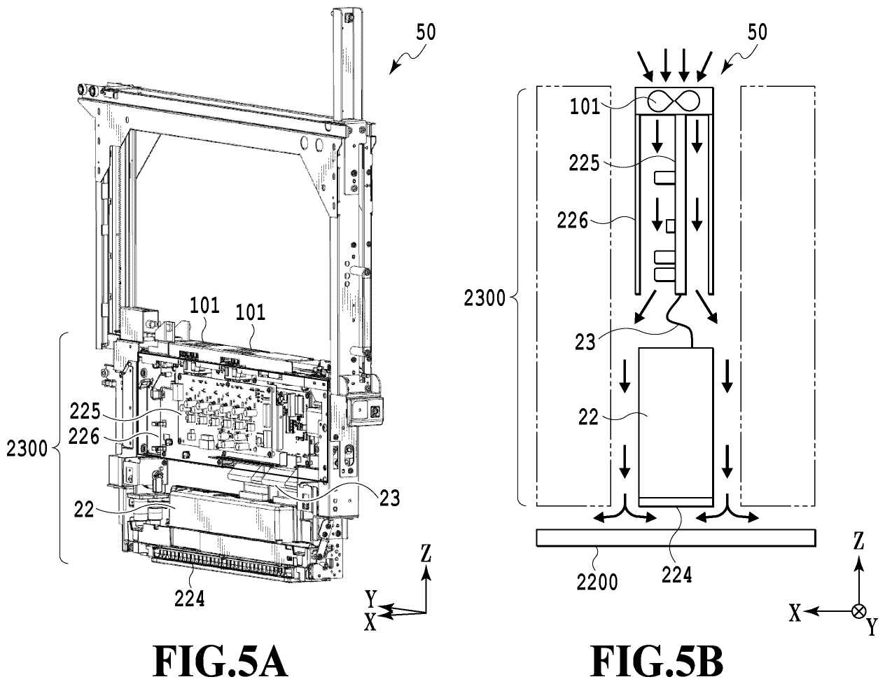

FIG. 5A is a perspective view illustrating a printing unit 50 corresponding to one printing head 22 in the printing unit 2300, and FIG. 5B is a schematic view of the printing unit 50 and illustrates the air flow with an arrow. There is an electric substrate 225 connected to the printing head 22 with a flexible substrate 23 above the printing head 22 in the Z direction. The electric substrate 225 controls the ejection of the printing head 22 and is energized all the time while the printing head 22 is operating. The electric substrate 225 is covered with a sheet metal 226; however, the sheet metal 226 is illustrated as a transparent part in FIG. 5A. The first air flow generation structure 101 is arranged above the electric substrate 225 farther in the Z direction. As described above, the first air flow generation structure 101 fills the role to send the air above the printing unit 2300 in the Z direction to the ejection port surface 224. In this case, it is also possible to restate each of the printing unit 2300, the printing unit 50, and the printing head 22 as a printing unit.

The air flow generated by the first air flow generation structure 101 passes through the vicinity of the electric substrate 225 and flows toward the printing head 22. In this process, the sheet metal 226 fills the role to control the air flow so as not to diffuse while the air flow passes through the vicinity of the electric substrate 225. Therefore, it is preferable to arrange the sheet metal 226; however, it is possible to flow the air flow toward the printing head 22 also in a case without the sheet metal 226. In the present embodiment, the electric substrate 225 is arranged above the printing head 22 in the Z direction; however, the positional relationship with one another is not limited. It is possible to appropriately design the electric substrate 225 taking into consideration a space configuration inside the printing apparatus, such as including the electric substrates of all the printing heads in a position away from the printing head 22 or inside the printing head. It should be noted that, in this case, it is necessary to additionally include a heat source to suppress the condensation between the first air flow generation structure 101 and the printing head 22, and details are described later.

In the present embodiment, the electric substrate 225 functions as the heat source that can increase the temperature of the air flow. Therefore, the electric substrate 225 is arranged such that the heat generated by the electric substrate 225 efficiently flows to the ejection port surface 224 below the printing head 22 in a −Z direction by the air flow from the first air flow generation structure 101.

According to FIG. 5B, the air flow generated by the first air flow generation structure 101 passes through the electric substrate 225, passes by the printing head 22, and flows into the ejection port surface 224. In this process, it is preferable to provide a partition illustrated with a dash-double-dot line in front of and back of the printing head 22 in the conveyance direction (the X direction) because this controls a traveling direction of the air flow, and the air flow is likely to flow under the printing head 22. Note that, as the partition, it is possible to use another unit such as an adjacent printing unit 50, a partition of a sheet metal, and the like. Particularly, in a case of using the multiple printing heads, the printing head of the other color that is arranged adjacent fills the role of the partition and controls the air flow.

The air flow configuration in the present embodiment produces an effect particularly in a case where the interval between the adjacent printing heads 22 is narrower than a width of each head in the X direction. A wider interval between the adjacent printing heads 22 requires stronger airflow generated by the first air flow generation structure 101. However, in some cases, the excessively strong airflow generates air turbulence inside the apparatus, which prevents the control of a liquid ejection direction, and a trouble such as ejection miss-alignment is caused.

Therefore, preferably, it is desirable to arrange the multiple printing heads 22 in the conveyance direction (the X direction) and to set a distance between the printing heads arranged side by side with no contact between the printing heads 22 within a range narrower than the width of the printing head 22 in the X direction. It is preferable that the adjacent printing heads 22 have no contact in terms of suppressing the inhibition of the air flow blown from the first air flow generation structure 101 to the ejection port surface 224. Additionally, since the interval between the adjacent printing heads 22 narrower than the width of the printing head 22 in the X direction can suppress the diffusion of the air flow blown from the first air flow generation structure 101 to the ejection port surface 224, it is desirable for the interval to be as narrow as possible.

In the present embodiment, the width of the printing head 22 in the X direction is 55 mm, and the interval between the adjacent printing heads 22 is about 10 mm; thus, the air flow generated by the first air flow generation structure 101 is efficiently blown to the ejection port surface 224. A not-illustrated scanner is arranged next to the printing head 22 corresponding to the Bk color positioned at the end of the adjacent multiple printing heads 22 at the interval of about 10 mm, and thus the air flow is efficiently blown to the ejection port surface 224.

In the present embodiment, the air flow generated by the first air flow generation structure 101 passes through the vicinity of the electric substrate 225 as the heat source and flows into the ejection port surface 224 in a high-temperature state. Thus, it is possible to reduce a relative humidity of the air flow and to flow the air flow at the increased temperature into the ejection port surface 224. That is, the air containing water is heated by the heat source, and the temperature is accordingly increased in a state in which the water content in the air is reduced or substantially remains; therefore, the relative humidity of the air flow with respect to the ambient air is decreased.

The decrease in the relative humidity in the air flow can reduce the possibility of the occurrence of the condensation due to change of the environment. On the other hand, the air at the increased temperature directly increases a temperature of a portion having a high risk of the occurrence of the condensation. In general, the condensation phenomenon occurs in a case where a temperature of an object falls below the dew point temperature of a peripheral environment. Therefore, with the temperature of the ejection port plate 223 and the face cover 227 of the ejection port surface 224 (see FIG. 2) being increased by the heated air flow continuously flowing therein, it is possible to reduce the risk of the occurrence of the condensation.

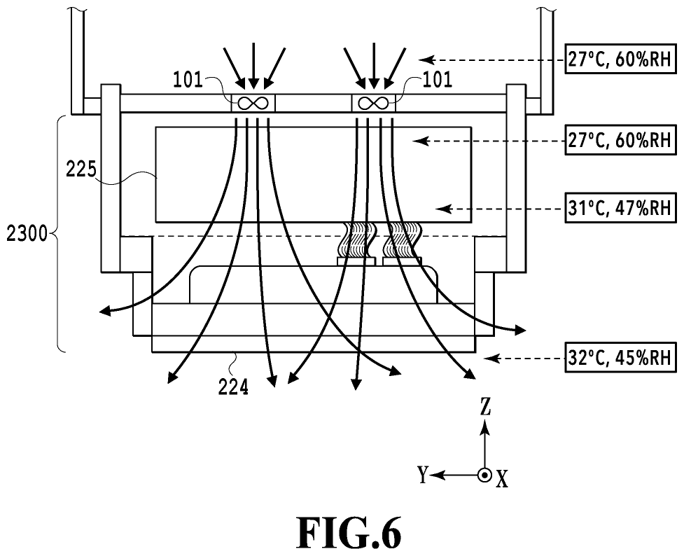

FIG. 6 is a diagram illustrating the air flow generated by the first air flow generation structure 101 in the printing unit 2300 with a flow line (a solid line arrow). The first air flow generation structure 101 is arranged in each of two portions close to the center of the printing head 22 in the Y direction. For example, in a case where the apparatus installation environment is 27° C. and 60% RH, the air (the outside air) sent by the second air flow generation structure 102 from the outside of the apparatus to the inside of the apparatus passes through the first air flow generation structure 101 at 27° C. and 60% RH, which are substantially the same as that of the outside of the apparatus. The temperature of the passing air flow is increased to about 31° C. by the electric substrate 225 at the increased temperature from 50° C. to 80° C. and flows into the ejection port surface 224. In this process, the water content in the air does not change or is reduced by the increased temperature, and in the present embodiment, the water content is reduced to the relative humidity of 47% RH. The air at the increased temperature directly enters the ejection port surface 224 and eventually reaches 32° C. and 45% RH.

Note that, in order to reliably achieve the increase in the temperature of the air flow by the electric substrate 225, it is desirable to arrange the electric substrate 225 on a straight line connecting two ends of the width of the printing head 22 in the Y direction and a width of the first air flow generation structure 101. Thus, it is possible to effectively utilize the present disclosure.

In the present embodiment, the electric substrate 225 is used as the heat source; however, a heat source that increases the temperature of the air flow may be additionally prepared. On the other hand, the electric substrate 225 that controls the ejection of the printing head 22 and the like is an essential unit to operate the liquid ejection apparatus and continuously operates; for this reason, it is necessary to include a cooling structure as a countermeasure for the temperature increase. Therefore, the first air flow generation structure 101 can be utilized not only as the cooling structure of the electric substrate 225 but also as a countermeasure for the condensation by sending the air flow that comes out during the cooling to the ejection port surface 224. According to the above, the present embodiment is preferable in terms of the efficiency of the apparatus operation.

Additionally, in the present embodiment, the conveyance belt 2201 used for the paper conveyance below the ejection port surface 224 has a configuration in which innumerable holes are opened on the belt and suction is performed via the holes. The configuration is not only useful for maintaining the smoothness of the ejection port surface 224 but also has an effect of sucking the air in the vicinity of the ejection port surface 224 and flowing the air under the belt. Therefore, it is preferable to be combined with the present disclosure in which the air is blown from above the printing head 22 to the ejection port surface 224 because displacement of the air in the vicinity of the ejection port surface 224 is prompted and the occurrence of the condensation is prevented.

### (First Modification)

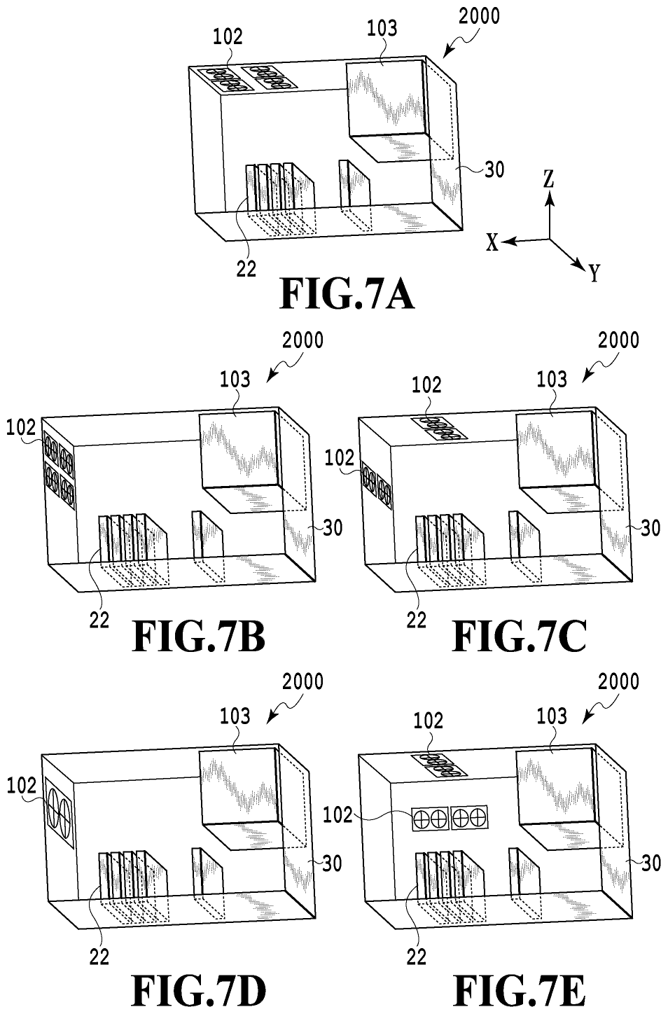

FIG. 7A is a diagram illustrating the print module 2000 of a first modification in the present embodiment. In the first modification, the number of the second air flow generation structures 102 is increased. A greater number of the second air flow generation structures 102 can allow the outside air to reach the first air flow generation structure 101 and can send the air flow to the ejection port surface 224 more easily.

### (Second Modification)

FIG. 7B is a diagram illustrating the print module 2000 of a second modification in the present embodiment. In the second modification, the positions of the second air flow generation structures 102 are changed. The positions of the second air flow generation structures 102 are not limited to an upper wall surface of a wall surface of the housing 30 in the Z direction, and the second air flow generation structures 102 may be provided on a side surface (the X direction) of the housing 30 in the in-use orientation. An advantage of providing on the side surface may be prevention of clogging of a filter with dirt and dust in the environment.

### (Third Modification)

FIG. 7C is a diagram illustrating the print module 2000 of a third modification in the present embodiment. In the third modification, the positions of the second air flow generation structures 102 are not limited to a single surface of the apparatus. The positions of the second air flow generation structures 102 are not limited to the single surface, and the second air flow generation structures 102 may be arranged across multiple surfaces. In other words, the second air flow generation structures 102 may be arranged separately on a side wall surface and the upper surface of the housing 30 in the in-use orientation. An advantage of arranging the second air flow generation structures 102 on the multiple surfaces may be reduction of points at which the air flow stagnates more than a case of the single surface.

### (Fourth Modification)

FIG. 7D is a diagram illustrating the print module 2000 of a fourth modification in the present embodiment. In the fourth modification, the size of each second air flow generation structure 102 is changed. It is possible to arrange the second air flow generation structure 102 while changing the size from small to large as needed. A greater size has an advantage to be able to increase the blown air amount of each fan; however, the uniformity of the blown air amount is less than a case of including multiple second air flow generation structures 102 in small size.

Note that, the size of the second air flow generation structure 102 used in the above-described embodiment is the axial flow fan of 120 square (120 mm×120 mm); in contrast, the second air flow generation structure 102 exemplified in the present modification arranges two axial flow fans of 240 square (240 mm×240 mm). Note that, the size of the second air flow generation structure 102 is not limited thereto and may be 60 mm square to 240 mm square (60 mm×60 mm to 240 mm×240 mm), for example. In addition, the shape is not limited to that described above.

### (Fifth Modification)

FIG. 7E is a diagram illustrating the print module 2000 of a fifth modification in the present embodiment. In the fifth modification, the second air flow generation structures 102 are arranged separately on the upper surface and a back surface. The second air flow generation structures 102 may be arranged separately on the upper surface and the back surface of the apparatus. Even with this configuration, it is possible to reduce the points at which the air flow stagnates more than a case of providing the second air flow generation structures 102 on the single surface.

### (Sixth Modification)

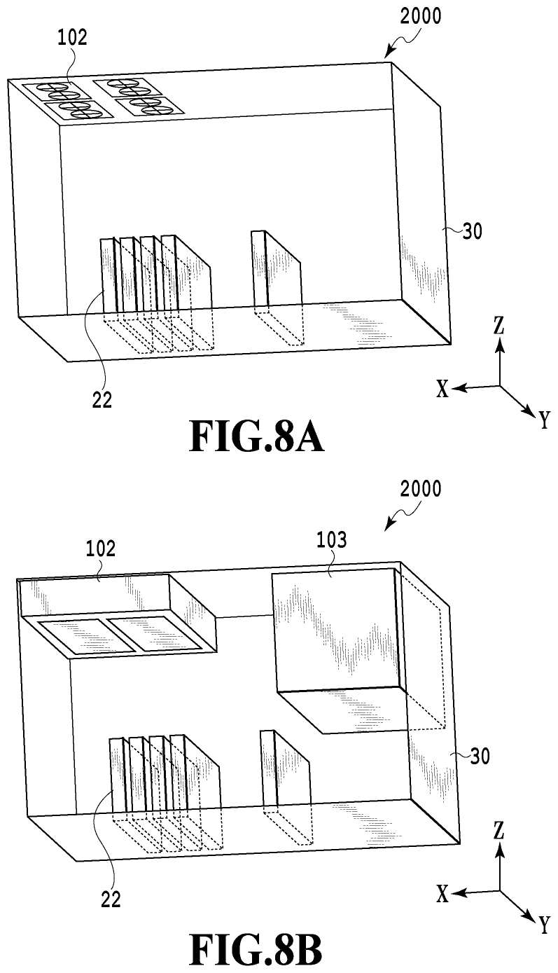

FIG. 8A is a diagram illustrating the print module 2000 of a sixth modification in the present embodiment. In the sixth modification, no PC space 103 is provided inside the housing 30, and the space inside the housing 30 is increased. The PC space 103 may be provided in the drying module 3000 or the like other than the print module 2000, for example. Even in a case where the PC space 103 is removed, the positional relationship between the second air flow generation structures 102 and the printing head 22 is not changed; for this reason, the blown air amount to the printing head 22 is substantially the same.

### (Seventh Modification)

FIG. 8B is a diagram illustrating the print module 2000 of a seventh modification in the present embodiment. The seventh modification is a configuration in which the type of the second air flow generation structure 102 is changed. In the present modification, an air conditioner is included as the second air flow generation structure 102. The second air flow generation structure 102 is not limited to the axial flow fan and may be anything as long as it is an apparatus that can displace the air such as the air conditioner.

### (Eighth Modification)

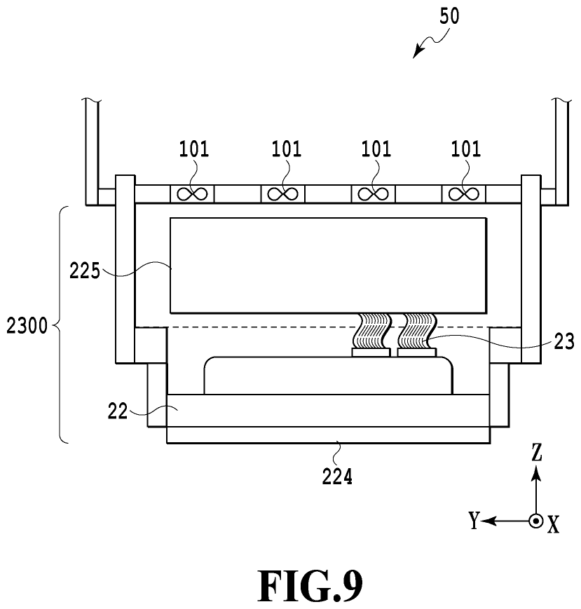

FIG. 9 is a diagram illustrating a part of the printing unit 50 of an eighth modification in the present embodiment. In the eighth modification, the printing unit 2300 includes four fans of the first air flow generation structures 101. The number of the first air flow generation structures 101 may be increased or decreased, and a greater number of the first air flow generation structures 101 can blow the air flow to the ejection port surface 224 more easily. In the present modification, it is possible to efficiently utilize the fans to cool down the electric substrate 225 as the heat source by providing a role to the fans also as the first air flow generation structures 101.

### (Ninth Modification)

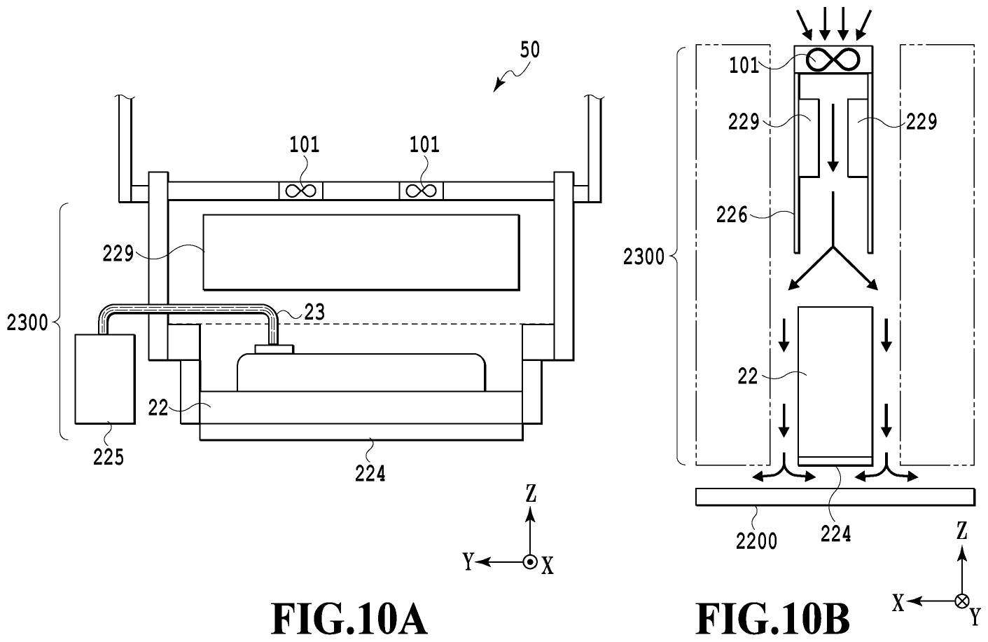

FIGS. 10A and 10B are diagrams illustrating a part of the printing unit 50 of a ninth modification in the present embodiment. In the ninth modification, an electric heater 229 is used as the heat source. With use of the electric heater 229 as the heat source, it is possible to provide the electric substrate 225 not only above the printing head 22 but also in another portion. In the printing unit 2300 of the present modification, as illustrated in FIGS. 10A and 10B, without using the electric substrate 225, the electric heater 229 that can generate heat is provided to the sheet metal 226, and the electric substrate 225 is provided to a place other than above the printing head 22. In the present modification, two electric heaters 229 are provided as illustrated in FIG. 10B, and the air flow generated by the first air flow generation structures 101 passes between the two electric heaters 229.

The temperature of the air flow blown down from above the printing head 22 in the Z direction by the fans of the first air flow generation structures 101 is increased by the electric heaters 229, and the air flow flows into the ejection port surface 224 below the printing head 22. The present modification has an advantage that it is possible to control the air flow temperature by adjusting the temperature of the electric heater 229.

### (Tenth Modification)

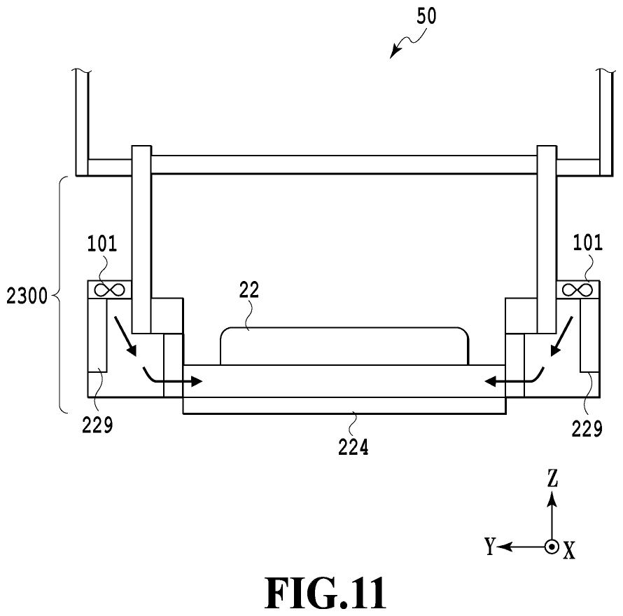

FIG. 11 is a diagram illustrating a part of the printing unit 50 of a tenth modification in the present embodiment. In the tenth modification, the first air flow generation structures 101 and the electric heaters 229 are arranged within a width of the printing unit 50 in the Y direction to sandwich the printing head 22 in the Y direction. That is, the first air flow generation structure 101 and the printing unit 2300 are arranged to overlap while viewing from the Y direction. Then, the temperature of the air flow blown by the fans of the first air flow generation structures 101 is increased by the electric heaters 229, and the air flow flows into the ejection port surface 224 from two end portions of the printing head 22 in the Y direction. According to the present modification, it is possible to provide flexibility to an apparatus design by effectively utilizing the space above the printing head 22 in the Z direction with the air flow flowing from a portion other than above the printing head 22 in the Z direction.

### (Eleventh Modification)

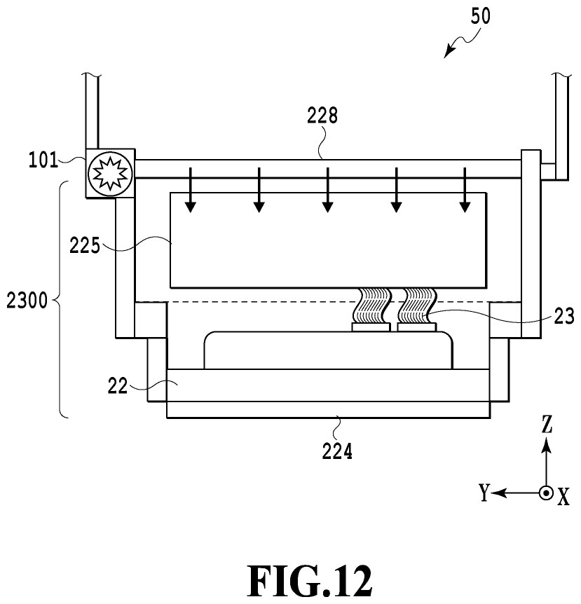

FIG. 12 is a diagram illustrating a part of the printing unit 50 of an eleventh modification in the present embodiment. In the eleventh modification, the sirocco fan is used as the first air flow generation structure 101 instead of the axial flow fan. The sirocco fan is arranged in a place that is between the adjacent printing heads, within the width of the printing unit 50 in the Y direction, and outside the range of the projected area of the printing head 22 in the Z direction. That is, the first air flow generation structure 101 and the printing unit 2300 are arranged to overlap while viewing from the Y direction. In addition, the air flow is blown from above the printing head 22 in the Z direction to the ejection port surface 224 via a duct 228. Thus, it is possible to consolidate the destinations of the blowing by the second air flow generation structure 102 to one place, and it is possible to blow the air flow all over the printing head 22 in the Y direction through the duct provided along the Y direction of the printing head 22.

### (Twelfth Modification)

In the above-described modifications, the print module 2000 includes the second air flow generation structure 102; however, no second air flow generation structure 102 may be included. In this case, a configuration in which a part of the housing 30 is opened to take the outside air therein without the air stagnation inside the housing 30 may be applied.

Note that, the above-described modifications may be implemented in appropriate combination as much as possible.

Thus, the first air flow generation structure 101 is arranged such that at least a part thereof overlaps the printing head 22 in the conveyance direction, and the air flow can be blown to the ejection port surface 224 of the printing head 22. In addition, the heat source is provided between the first air flow generation structure 101 and the printing head 22 to increase the temperature of the air flow from the first air flow generation structure 101. Therefore, it is possible to provide a liquid ejection apparatus that suppresses the occurrence of the condensation in the printing head 22 and suppresses the increase in the size of the apparatus.

### Second Embodiment

A second embodiment of the present disclosure is described below with reference to the drawings. In the present embodiment, a configuration in which the multiple printing heads 22 print the image on a rolled sheet that moves along the conveyance route with a curvature is described. Note that, hereinafter, a characteristic configuration of the present embodiment is described.

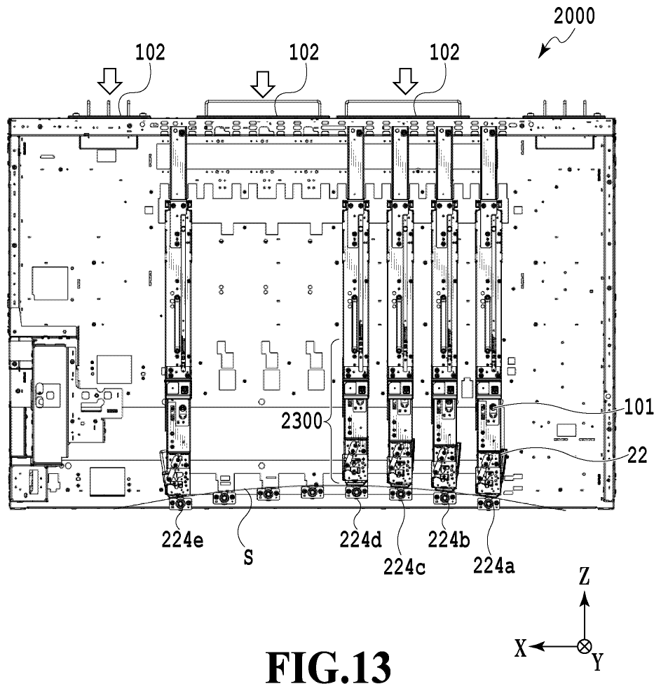

FIG. 13 is a diagram illustrating the print module 2000 of the present embodiment. The print module 2000 in the present embodiment has a curvature in a conveyance path of the sheet. The multiple printing heads 22 are provided along the conveyance path with the curvature. The printing head 22 closer to a curvature vertex of the conveyance path includes the ejection port surface 224 closer to horizontal, and the printing head 22 farther from the vertex has a greater tilt of the ejection port surface 224 with respect to a horizontal plane. In this aspect, the width between the printing heads 22 needs to be wider than that in the above-described first embodiment in which all the printing heads are arranged horizontally.

The sheet is supported by rollers (224a to 224e) provided in positions facing the printing heads 22. In a case of a roll paper type conveyance system, the tension of the sheet is eased and the ejection port surface is unstable in a case where an interval between the rollers supporting the sheet is not widened. Therefore, as for the printing heads facing the rollers (224a to 224e), the interval between the adjacent printing heads is also widened. In the present embodiment, with respect to the width of about 55 mm of the printing head 22 in the X direction, the interval between the adjacent printing heads is about 50 mm at a maximum and is about 40 mm even in the minimum position at an end portion.

The other configurations are the same as that in the first embodiment. The second air flow generation structure 102 blows the outside air to the first air flow generation structure 101. Then, the air flow at the increased temperature that passes through the vicinity of the electric substrate 225 as the heat source is sent to the ejection port surface 224 of each printing head by the first air flow generation structure 101, and the air below the printing head is displaced. The modification described in the first embodiment is also adoptable to the present embodiment as needed. Note that, in a case of the roll paper type conveyance system, a mode in which no curvature is provided to the conveyance path of the sheet may be applied. In this case, a publicly-known configuration such as a mode of providing a pair of rolls or the mode of providing a conveyance belt and a roll may be applied to maintain the tension of the roll paper.

In the present embodiment, since the interval between the adjacent printing heads is wide unlike the first embodiment, a whole size of the print module 2000 is great. However, in the present embodiment having the curvature, the air flow blown from above the printing head can gradually flow into the ejection port surface 224 below the printing head, and thus there is an advantage of easy displacement of the air.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115817, filed Jul. 19, 2024, which is hereby incorporated by reference herein in its entirety.

What is claimed is:

1. A liquid ejection apparatus, comprising:
a printing unit in which an ejection port from which a liquid is ejected onto a printing medium is arrayed in a second direction crossing a first direction in which the printing medium is conveyed;
a first air flow generation unit that can generate an air flow; and
a heat source that can generate heat, wherein
the first air flow generation unit and the printing unit are arranged in a position in which the first air flow generation unit and the printing unit overlap in the first direction, and the air flow generated by the first air flow generation unit passes through the heat source and reaches an ejection port surface provided with the ejection port in the printing unit.

2. The liquid ejection apparatus according to claim 1, further comprising:
a second air flow generation unit that can take outside air into the apparatus, wherein
the second air flow generation unit can blow the taken outside air to the first air flow generation unit.

3. The liquid ejection apparatus according to claim 2, further comprising:
a plurality of the second air flow generation units.

4. The liquid ejection apparatus according to claim 2, wherein
the heat source is an electric substrate that controls the liquid ejection apparatus.

5. The liquid ejection apparatus according to claim 2, wherein
a plurality of the printing units are arranged in the first direction, and
the first air flow generation unit is included in each of the printing units.

6. The liquid ejection apparatus according to claim 1, wherein
the first air flow generation unit is arranged above the printing unit.

7. The liquid ejection apparatus according to claim 2, wherein
the second air flow generation unit is provided on a wall surface of a housing storing the printing unit, the first air flow generation unit, and the heat source.

8. The liquid ejection apparatus according to claim 7, wherein
the second air flow generation unit is provided on an upper wall surface of the housing.

9. The liquid ejection apparatus according to claim 7, wherein
the second air flow generation unit is provided on a side wall surface of the housing.

10. The liquid ejection apparatus according to claim 7, wherein
the second air flow generation unit is provided on an upper wall surface and a side wall surface in the first direction of the housing.

11. The liquid ejection apparatus according to claim 7, wherein
the second air flow generation unit is provided on an upper wall surface and a side wall surface in the second direction of the housing.

12. The liquid ejection apparatus according to claim 1, wherein
the first air flow generation unit is an axial flow fan of 16 mm×16 mm to 60 mm×60 mm.

13. The liquid ejection apparatus according to claim 2, wherein
the second air flow generation unit is an axial flow fan of 60 mm×60 mm to 240 mm×240 mm.

14. The liquid ejection apparatus according to claim 7, wherein
the second air flow generation unit is an air conditioner.

15. The liquid ejection apparatus according to claim 2, wherein
the heat source is a heater.

16. The liquid ejection apparatus according to claim 1, wherein
the air flow generated by the first air flow generation unit passes between two heaters as the heat source and reaches the ejection port surface.

17. The liquid ejection apparatus according to claim 7, wherein
the heat source is arranged at each of two end portions of the printing unit in the second direction, and the first air flow generation unit flows the air flow into the ejection port surface from the two end portions of the printing unit in the second direction.

18. The liquid ejection apparatus according to claim 1, wherein
the first air flow generation unit is a sirocco fan.

19. The liquid ejection apparatus according to claim 1, further comprising:
a printing medium conveyance path with a curvature.
